(19) United States
(12) Patent Application Publication
(10) Pub. No.: US 2009/0119193 A1
(43) Pub. Date: May 7, 2009

(54) AUTOMATED TRANSACTION CALCULATIONS WITH SCRIPTED RULE SETS

(76) Inventor: John C. Selleck, Sequim, WA (US)

Correspondence Address: PERKINS COIE LLP;PATENT-SEA, P.O. BOX 1247, SEATTLE, WA, 98111-1247, US

(21) Appl. No.: 11/934,689

(22) Filed: Nov. 2, 2007

(51) Int. Cl. G06Q 40/00

(52) U.S. Cl. 705/31; 705/30

(57) ABSTRACT

A rule-based payment system is described that divides a payment among multiple parties by invoking one or more deduction rules. The rule-based payment system typically operates as part of a software application that provides many functions relevant to a real estate or other commission-based practice. Rules can be added to the system at any time without modifying the software. Rules are scripts that the software application can invoke to carry out deductions specific to a particular environment. If the software application manufacturer wants to provide the software to multiple markets in many different environments, the software manufacturer can provide a different set of rules for each environment without modifying the software application itself. Thus, the rule-based payment system allows software to be shared among many markets while still having the flexibility of custom-built software.

### BACKGROUND

A typical real estate transaction involves an initial payment, such as a commission, that is split among multiple parties. For a real estate broker, the process is one of winnowing down the initial amount until a final amount is left that is profit. In a typical home sale, a listing agent signs a listing agreement with a home seller that provides for a six percent commission based on the sale price of the home. This six percent commission is typically divided in half with the listing agent receiving three percent and the selling agent that found the buyer receiving three percent. Each of these agents typically works for a broker, and their respective commissions will be further divided to pay for overhead and profit due to the broker.

One size does not fit all in the real estate industry. Different states impose different taxes, licensing fees, and other payments that a real estate broker must pay. Such payments may be made annually, quarterly, or even per transaction. Even commission schemes vary greatly from broker to broker and from agent to agent within the same brokerage. For example, one broker may offer a bonus after the first $1 million in sales each year. As another example, another broker may offer different fees based on the seniority of agents or their average sales over the past several years. Supporting all of the different possibilities for how a commission can be divided requires enormous flexibility from software.

Many brokerage software applications have failed because of the difficulty of accommodating many different markets and environments. One failed approach is attempting to force customers to conform to a model followed by the software that is not natural for the customer's business. For example, some brokerage software provides a fixed list of deductions, such as for a selling agent and listing agent. However, this approach does not work for many special situations that routinely occur. Another failed approach is to provide a custom version of the software tailored to each environment. This can lead to different versions of the software for each country or state, regions within a state, or even offices in the same town. This level of custom development is difficult for the software manufacturer and limits the number of markets that the manufacturer can successfully enter and support.

### BRIEF DESCRIPTION OF THE DRAWINGS

FIG. 1 is a block diagram that illustrates the components of a rule-based payment system in one embodiment.

FIG. 2 is a flow diagram that illustrates the processing of a payment by various rules in one embodiment.

FIG. 3 is a flow diagram that illustrates the process of creating a new rule in one embodiment.

FIG. 4 is a block diagram that illustrates the interaction of rules with a brokerage software application in one embodiment.

FIG. 5 is a display diagram that illustrates a user interface displayed by the rule-based payment system for viewing a transaction in one embodiment.

FIG. 6 is a display diagram that illustrates a user interface displayed by the rule-based payment for creating rules system in one embodiment.

### DETAILED DESCRIPTION

### Overview

A rule-based payment system is described that divides a payment among multiple parties by invoking one or more deduction rules. For example, one rule may indicate that a selling agent is entitled to 50 percent of the payment. Parties may include people or entities, such as a franchise or government agency. The rule-based payment system typically operates as part of a software application that provides many functions relevant to a real estate or other commission-based practice. Rules can be added to the system at any time without modifying the software. For example, a broker can draft a rule and add the rule to the system without having any software development skills by using a graphical user interface familiar to the broker. Rules are scripts that the software application can invoke to carry out deductions specific to a particular environment. For example, one environment is a residential real estate brokerage. If the software application manufacturer wants to provide the software to multiple markets in many different environments, the software manufacturer can provide a different set of rules for each environment without modifying the software application itself. For example, one market may be Seattle, Wash., whereas another market may be Vancouver, Canada. Each market may have its own tax rules, agent rules, and so forth. Thus, the rule-based payment system allows software to be shared among many markets while still having the flexibility of custom-built software.

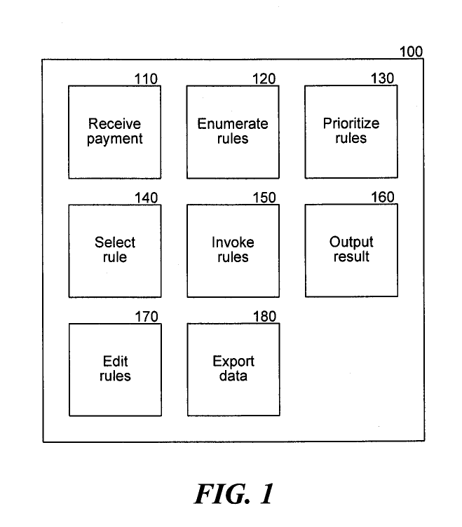

FIG. 1 is a block diagram that illustrates the components of the rule-based payment system in one embodiment. The rule-based payment system 100 contains a receive-payment component 110, an enumerate-rules component 120, a prioritize-rules component 130, a select-rule component 140, an invoke-rules component 150, an output-result component 160, an edit-rules component 170, and an export-data component 180. The receive-payment component 110 receives information about an initial payment that is to be divided among multiple parties related to a transaction. For example, in a real estate purchase and sale transaction, a commission payment may be received by the listing agent that is to be divided among the listing agent, the listing agent's broker, a buyer's agent, and the buyer's agent's broker. The enumerate-rules component 120 enumerates the rules accessible by a software application, such as a real estate brokerage software application. For example, rules may be stored as files on a data store accessible to the software application. The prioritize-rules component 130 establishes a priority among multiple rules that determines the order in which the system 100 invokes the rules. The select-rule component 140 selects the next rule to invoke. For example, the component 140 may select the rule based on the priority of rules and characteristics of the received payment. For example, a transaction in one locale may implicate different rules than a transaction in another locale (e.g., based on tax or other differences).

The invoke-rules component 150 invokes each rule, passing in a starting amount and receiving a resulting amount based on the steps performed by the rule. For example, the rule may be a script that deducts amounts of money from the starting amount based on one or more conditions. The output-result component 160 outputs the resulting amount. The resulting amounts from some rules may be intermediate values that are stored or passed to a subsequent rule. Other resulting amounts may be displayed to a user, listed in a report, or exported to a financial application. The edit-rules component 170 provides an interface for adding new rules and modifying existing rules. For example, the edit-rules component 170 may provide a graphical user interface for creating and modifying rules. The export-data component 180 allows data to be exported from the rule-based payment system to an external application, such as an accounting application. For example, after the system determines the amount due to each party in a transaction, the user may export the data to an accounting application for producing checks to pay each party.

The computing device on which the system is implemented may include a central processing unit, memory, input devices (e.g., keyboard and pointing devices), output devices (e.g., display devices), and storage devices (e.g., disk drives). The memory and storage devices are computer-readable media that may be encoded with computer-executable instructions that implement the system, which means a computer-readable medium that contains the instructions. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, and so on. The computer systems may include cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

### Deduction Rules

Many types of deductions can be taken from the initial payment. The broker may charge each agent a per-transaction fee as well as an annual fee. The government where the broker is located may impose taxes on each transaction, including federal, state, county, provincial, and other taxes. The agent may share his or her commission from the payment with one or more other agents, each of whom may receive a different percentage of the commission. The broker may also pay a franchise fee to associate with a nationally recognized real estate franchise (e.g., Coldwell Banker or Century 21).

Each of these fees, taxes, and commissions may be a flat amount, an amount based on the value of the transaction, or an amount calculated in numerous other ways. For example, a broker may pay a $10 franchise fee per transaction up to an annual maximum of $1,000. Taxes may be due quarterly or annually, but attributed by the broker as a percentage of each transaction. Agent commissions may be based on the value of the transaction as well as on annual performance. For example, the agent may get a higher commission after passing a minimum sales threshold.

Although referred to as deduction rules herein, rules can also include additions rather than deductions. For example, one rule may specify that an agent is to receive a selling bonus after selling a certain dollar amount of real estate each calendar year. When the agent's sales reach the dollar amount, the rule may add the bonus amount to the agent's commission. The bonus may exceed the payment received for the particular transaction, so the bonus may be added from a separate account of the broker rather than being deducted from the original payment. Another example of a deduction that can be implemented as a rule is the Keller Williams profit sharing model, which provides a recruiting bonus to agents. Keller Williams has adopted a model of providing passive income to an agent based on profits generated by another agent that the agent refers to the company. This passive income comes from the broker's profit, not from the other agent's commission.

In some embodiments, the rule-based payment system receives an account associated with each rule, and each rule adds or deducts money from the received account. For example, an account may be created for each agent in a brokerage, and when a rule is applied that specifies a commission for an agent, the rule may add money to that agent's account. Similarly, accounts may be created for the payment of taxes and other fees. The broker may also have one or more accounts, such as a residential sales account and a commercial sales account. The software associated with the rule-based payment system may provide reports based on transactions related to each account.

In some embodiments, the rule-based payment system establishes a priority for each rule relative to other rules. The system invokes the highest priority rule first, followed by the other rules in order by priority. The priority of rules can ensure that the most important deductions are taken first. In some situations, there may not be enough money involved in the transaction to cover all deductions, so taking the most important deductions first ensures an appropriate distribution of money.

The rule-based payment system may group rules into prioritized tiers. For example, rules may be grouped into first, second, and third tiers, where the first tier is performed first, then the second tier, and then the third tier. Tiers can be useful where an intermediate value based on deductions from a payment is used to calculate another value. For example, an agent commission may be based on the value of the transaction after the broker's overhead has been paid. In this example, rules that account for the broker's overhead may be in the first tier, and rules that deduct the agent's commission may be in the second tier.

In some embodiments, the rule-based payment system allows an operator to override a rule to handle exceptions. In some instances, a rule may not lead to a desired result. To handle these instances, the rule-based payment system allows an operator to enter a value that takes the place of the output from the rule. This allows the operator to handle rare exceptions without making modifications to the rules or software application.

In some embodiments, the rule-based payment system applies rules in multiple iterations. For example, the system may apply one set of rules, obtain one or more result values, and then apply rules to the result values. The multiple iterations may be based on the tiers of rules described herein. For example, the rule-based payment system may apply rules from the first tier, report one or more intermediate values, and then apply rules from a second tier and report another set of values.

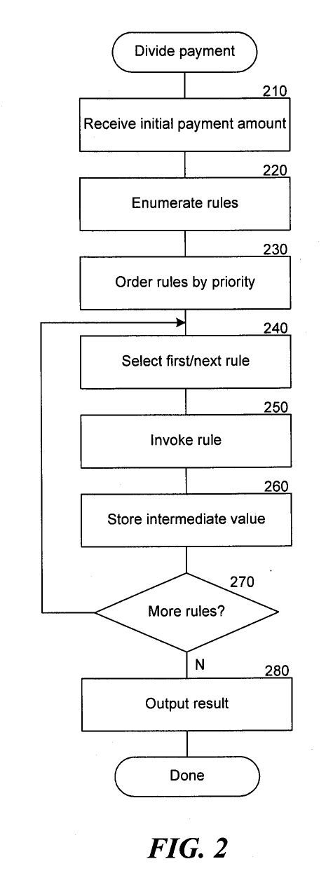

FIG. 2 is a flow diagram that illustrates the processing of a payment by various rules in one embodiment. These steps are performed by the system when a payment is received that is to be divided among multiple parties. In step 210, the system receives information corresponding to an initial payment amount. For example, the initial payment amount may be a commission received from a real estate purchase and sale transaction. In step 220, the system enumerates rules that apply to the transaction. For example, some rules may apply to all transactions while others may only apply to transactions in a particular geographic area. In step 230, the system orders the rules by priority. For example, the rules may be organized by tiers with rules in one tier having higher priority than rules in another tier. In step 240, the system selects the first enumerated rule. In step 250, the system invokes the selected rule. For example, if the rule is a script, then the system runs the script passing the input parameters requested by the rule and receiving one or more output values determined by the steps of the rule. In step 260, the system stores any output values as intermediate values. The intermediate value may be kept in memory for passing to the next rule, or may be stored in nonvolatile memory for further processing or display to the user. In decision step 270, if there are more rules, then the system loops to step 240 to select the next rule, else the system continues at step 280. In step 280, the system outputs the result of the application of the set of rules. For example, the system may store accounting entries in a database that represent payments due to each party in the transaction, broker profit, taxes paid, and so forth. After step 280, these steps conclude.

### Editing Rules

In some embodiments, the rule-based payment system provides a rule-editing interface. The system may provide a graphical user interface, such as a series of forms into which the user enters information to specify the elements of a rule. For example, the user may specify the account to which a rule applies, the conditions under which the rule should be invoked, the amount that the rule deducts from a received payment, and so on. The system may also provide a programmatic interface through which rules can be created, so that third-party application developers can develop libraries of rules compatible with the rule-based payment system. For advanced users, the system may receive text input that allows the advanced users to directly enter the elements of a rule using a programmatic scripting language. Each of these interfaces allows new rules to be added and existing rules to be modified.

Rules may have many different elements, such as an agent or account to which the rule applies (e.g., all agents in an office, agents by seniority, agents at a particular sales rung, etc.), a duration to apply the rule (e.g., once a month, first transaction of the month, once a week, etc.), a value (e.g., a dollar amount), a cap (e.g., stop applying rule after $100), and so forth. In some cases, a rule does not have any elements, such as when a rule is used to report a leftover value after other rules have been applied. In other cases, a rule may deduct a specified flat amount with no other conditions. For example, a rule may always deduct $300 for each transaction. Many types of rules are possible using this flexible approach.

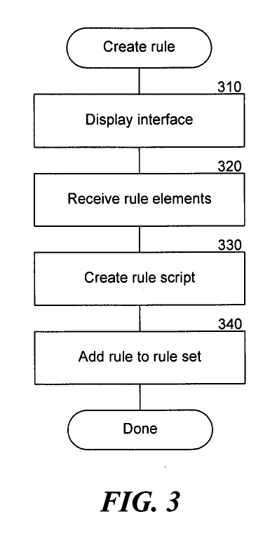

FIG. 3 is a flow diagram that illustrates the process of creating a new rule in one embodiment. The edit-rules component 170 is invoked when a user makes a request to create a new rule or modify an existing rule. In step 310, the component displays a user interface for creating a rule. For example, the component may display a form-based interface through which the user enters elements of the rule. Alternatively or additionally, the interface may be a programmatic interface that receives elements of new rules from another application. In step 320, the component receives elements of the rule through the interface. For example, using a graphical user interface a user may create a rule that specifies a particular payee (e.g., a listing agent), an amount to pay, conditions that affect the amount and frequency of the payment (e.g., percentage of sale price, first transaction of the month, and so on), and what to do with the result value (e.g., store it for later processing, display it to the user, or export it to another application). In step 330, the component creates a script that performs the specified conditions and elements to determine the result value. In step 340, the component adds the rule to a set of rules accessible to an application that invokes the rules. For example, the component may store the rule in a folder within a file system that contains rules used by a software application. After step 340, these steps conclude.

Those of ordinary skill in the art will recognize numerous methods of implementing the rules and creating an application interface with the software that invokes the rules. For example, the rules may be embodied in one or more software modules that are loaded by the application, and the modules may contain a function related to each rule that the application invokes. Alternatively, the application may provide an object model application-programming interface (API), and the rules may be written in a scripting language that uses the API to carry out the steps of each rule.

In some embodiments, customers access the rule-based payment system through a web- or terminal-based interface. Traditional software is distributed on a Compact Disc (CD) that is used to install the software on the customer's computer system. However, by using a web-based approach in which the customer accesses a web site that hosts the software, the rule-based payment system manufacturer is able to handle upgrades and maintenance without involving customers. In addition, because rules are stored on servers hosted by the system manufacturer, the manufacturer can make modifications to the system based on how the rules are being used. For example, if many customers are creating the same rule that is not offered in a set of base rules provided with the system, the manufacturer can add that rule to the base rules of the system so that it is shared with all customers.

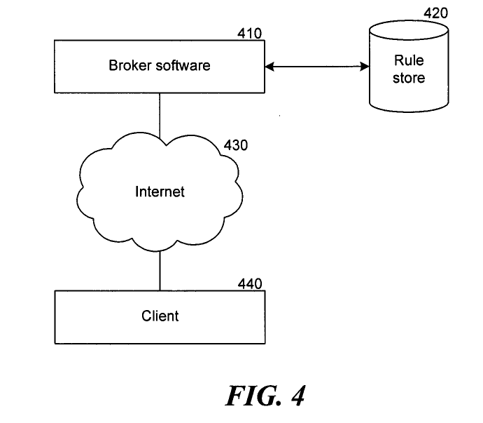

FIG. 4 is a block diagram that illustrates the interaction of rules with a brokerage software application in one embodiment. The broker software 410 accesses a rule store 420 to enumerate and invoke rules applicable to a particular transaction. A user, such as the broker, can add new rules to the rule store 420 that will affect future transactions using the broker software 410. The rule store 420 may be a database, file system, module, or any other store that the broker software 410 can access. The broker software 410 may be a hosted application accessible through a network, such as the Internet 430, using a client device 440. For example, the client device 440 may be a computer running at a remote location that the broker uses to run a real estate brokerage.

### Reporting

In some embodiments, the rule-based payment system is used to produce reports. At any particular time, a broker may have a number of completed sales, pending sales, and projected sales. The rule-based payment system can provide reports that allow the broker to determine a current or projected status of a transaction, for example to plan appropriately to run the business. For example, one report allows the broker to project revenue based on existing contracts for the next 60-90 days. Many types of reports are possible, such as reports based on the performance of a particular agent, the performance of an office, the projected sales for the rest of the year based on the beginning of the year and historical trends, and so forth. The broker or other user of the system may also run reports to determine the amount of quarterly tax payments.

### Data Export

In some embodiments, the rule-based payment system exports information to accounting, tax, reporting, or other software. For example, the system may export information about movements of money between accounts to Intuit QuickBooks, a popular small business accounting software application. Intuit provides a software development kit (SDK) that can be used to interact with QuickBooks, and the rule-based payment system uses the SDK to post information to accounts in QuickBooks. For example, the rule-based payment system may maintain tables of people (e.g., agents, brokers), places (e.g., offices), and things (e.g., supplies and other depreciable items) that correspond to similar items or payees in QuickBooks. For example, each agent may be represented as a payee in QuickBooks. After the rule-based payment system has determined a payment due for each agent, QuickBooks or other financial software can be used to produce checks for each agent.

The tables of people, places, and things contain items that are referenced by rules. For example, a rule that provides a commission payment to an agent references the agent's entry in the people table. A rule that provides a bonus to an office for hitting a sales target may reference the office in the places table. A rule that charges an agent for office supplies or furniture may reference the things table. Each item in the table can be associated with an account or other item in an accounting software application, and when the user requests to export information to the application, the system uses the association to post information to the correct account.

### Example Workflow

The following is an example of a workflow from a transaction using the rule-based payment system:

| | |
|---|---|
| 1. | An initial gross amount is brought manually into the system, referred to as “A.” |
| 2. | The system contains a directory of “People, Places, and Things” that are named |
| | with a defining script. The script also serves as the primary key field of the table structure, |
| | referred to as “B.” |
| 3. | Ancillary to B is a table of rule set options (referred to as “C”), which is named by |
| | the script name of A. Each rule set contains parameters that define duration (monthly, |
| | quarterly, etc.), dollar limits (caps), conditional application parameters like single agent, |
| | agent tag list, office location, etc. There can be virtually an infinite number of these in a |
| | given system. The rule set also contains a chart of accounts number used later in the |
| | process of passing journalized data into QuickBooks. |
| 4. | The object of the math process is to define how value A is to be divided up in a |
| | “top-to-bottom” progression. |
| 5. | The progression contains two tiers of “take-offs” defined by the inclusion of one or |
| | more rule sets (C). These rule sets (C) act to define the value of the rule set according to |
| | the factors contained within it. An example of this might be a take-off that only occurs |
| | once a month or has a cap of X dollars (these are rule parameters contained within C). |
| | Percentages contained within the rule set may be applied or fixed dollar amounts can be |
| | specified. The sum of the take-off values (c) is then subtracted from A to yield an |
| | intermediate value (referred to as “D”). |
| 6. | The process is then repeated usually with rule sets (C) that involve D |
| | mathematically (since this value is not known until take-offs from A have been calculated) |
| | to yield a value referred to as “E.” |
| 7. | D minus E then equals another intermediate value (referred to as “F” - usually the |
| | basis for the calculation of agent commission values, the sum of which will be referred to |
| | as “G”). |
| 8. | Agent commission values are calculated by a table lookup process to determine a |
| | gross agent commission value. This value is then subject to the application of rule sets |
| | (C) in the same way they have been applied elsewhere, but with items specific to agent |
| | commission calculations. These might include things like fees or recovered expense |
| | items, etc., all of which contain rule parameters (described above). |
| 9. | The total of agent gross commission values is subtracted from intermediate value G |
| | to yield a preliminary transaction profit figure (H). |
| 10. | Rule set values from the agent commission calculations are (at the user's option) |
| | added back into H to derive a net transaction profit result. |

These calculations may be performed at any time during the life of the transaction, with the final calculation being performed at the time the transaction is actually paid out to each party. The paying-out process prints checks (optional) and takes each accounting-related component of the math process, and (using the chart of accounts number referenced in the rule set) converts the value into a double-entry accounting entry and passes it into accounting software, such as Intuit QuickBooks. This completes the payout process. The payment processed may also be reversed, such as to identify the source of any particular payment.

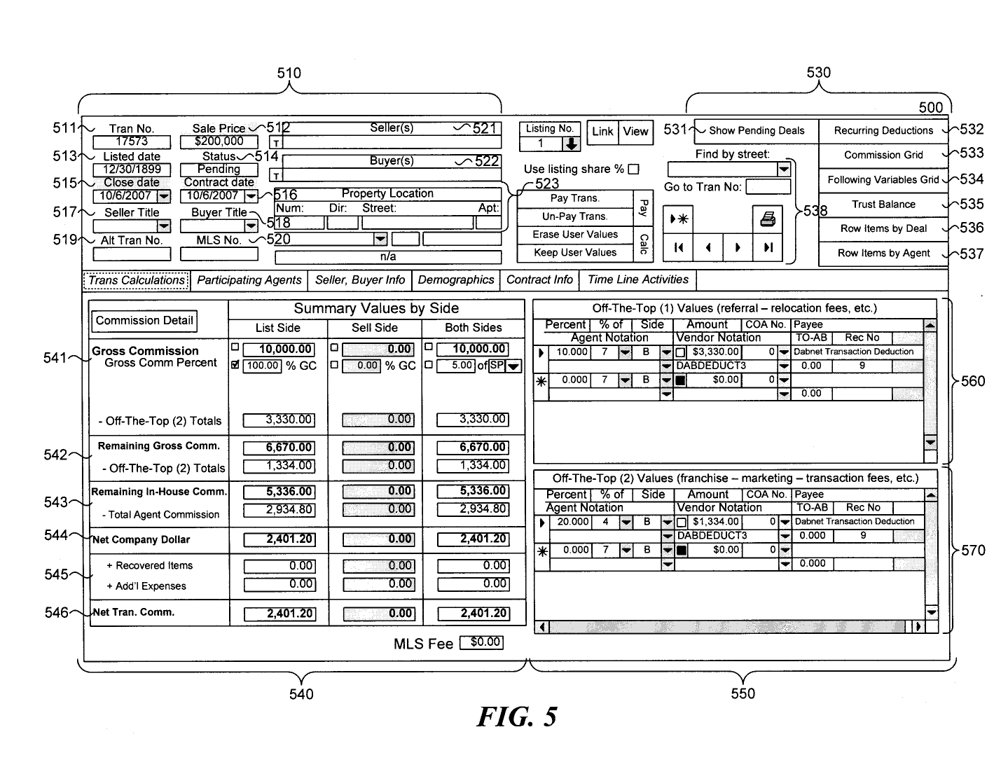

FIG. 5 is a display diagram that illustrates a user interface displayed by the rule-based payment system for viewing a transaction in one embodiment. The user interface comprises a form 500 that includes a transaction information area 510, an additional function area 530, a payment summary area 540, and a rule set area 550. The transaction information area 510 includes details that identify the transaction, such as a transaction number 511, a sale price 512, a listed date 513, a status 514, a close date 515, a contract date 516, a seller title 517, a buyer title 518, an alternate transaction number 519, a multiple listing service (MLS) number 520, a seller name 521, a buyer name 522, and an address 523 of the property involved in the transaction.

The additional function area 530 provides buttons for navigating to other transactions, displaying reports, and so forth. For example, the additional function area 530 may include a show-pending-deals button 531, a recurring-deductions button 532, a commission-grid button 533, a following-variables-grid button 534, a trust-balance button 535, a row-items-by-deal button 536, a row-items-by-agent button 537, and tools for navigating to other transactions 538, such as by searching for a street address.

The rule set area 550, lists rules sets that have been applied to produce the values displayed in the payment summary area 540. For example, the rule set area 550 displays rule set 560 and rule set 570. The payment summary area 540 summarizes how the payment is divided. For example, the area displays a gross commission 541 from which a value based on rule set 560 is deducted. This is followed by a remaining gross commission 542 from which a value based on the rule set 570 is deducted. Next is a remaining in-house commission 543 from which the agent commission is deducted. This results in a net company dollar amount 544, from which other expenses 545 may be deducted. The result is a net transaction commission 546 that represents potential profit to the broker or other business owner.

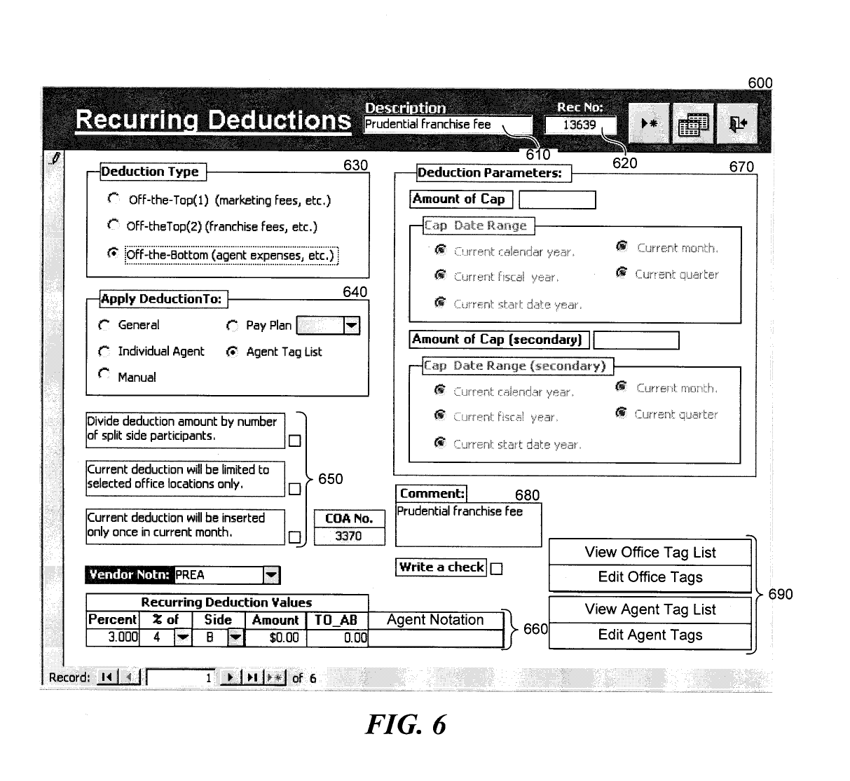

FIG. 6 is a display diagram that illustrates a user interface displayed by the rule-based payment for creating rules system in one embodiment. The user interface comprises a form 600 that includes a description 610, a record number 620, a rule tier area 630, a rule target area 640, a rule options area 650, a rule amount area 660, a rule parameter area 670, a comment 680, and navigation buttons 690. The description 610 provides a human-readable description of the rule that the form 600 describes. The record number 620 provides a numerical identifier for referencing the rule. The rule tier area 630 receives a selection of which tier the rule should belong to, such as a first tier related to off the top marketing fees. The rule target area 640 receives a selection of the target(s) of the rule, such as a particular agent, all agents fitting a description (such as those in a particularly sales bracket for the year), and so forth. The rule options area 650 receives additional options related to the rule. The rule amount area 660 receives recurring deduction values that affect the calculations performed by the rule. For example, the deduction values may specify a percentage of the transaction amount to deduct. The rule parameter area 670 receives additional parameters of the rule, such as a date range during which the rule applies. The comment 680 receives any text commentary that the creator of the rule wants to add for future reference. The navigation buttons 690 provide additional functions, and may link to other forms that the user can use to edit the rule.

### CONCLUSION

From the foregoing, it will be appreciated that specific embodiments of the rule-based payment system have been described herein for purposes of illustration, but that various modifications may be made without deviating from the spirit and scope of the invention. For example, although real estate brokerages and commissions have been used as an example, the system described herein can be applied to many different fields and environments where a commission or other payment is divided among multiple parties, such as insurance offices and stock brokerages. Accordingly, the invention is not limited except as by the appended claims.

I/We claim:

1. A computer-based method for dividing a first payment among multiple parties, the method comprising:
receiving in a software application information describing a first payment amount;
invoking one or more rules to apply deduction amounts from the first payment amount, wherein the rules are stored separately from the software application and can be added and updated without modifying the software application; and
reporting a second payment amount for at least one of the multiple parties based on the deductions from the first payment amount, wherein the second payment amount is a portion of the first payment amount.

2. The method of claim 1 wherein the software application is a real estate brokerage software application.

3. The method of claim 1 wherein the initial payment amount is a commission associated with a real estate transaction.

4. The method of claim 1 wherein invoking one or more rules comprises invoking scripts that encode instructions for each rule.

5. The method of claim 1 wherein the one or more rules have an associated priority and wherein invoking the one or more rules comprises invoking the rules in order by the associated priority.

6. The method of claim 1 further comprising exporting one or more amounts based on invoking the one or more rules to a separate accounting software application.

7. The method of claim 1 wherein at least one rule determines a commission for payment to a real estate agent.

8. The method of claim 1 wherein at least one rule determines an amount to deduct based on a volume of sales.

9. The method of claim 1 wherein at least one rule determines an amount to deduct based on a tax rate imposed by a governmental entity where the software application is used.

10. The method of claim 1 wherein at least one rule determines an amount to deduct based on a per transaction fee.

11. The method of claim 1 wherein at least one rule determines an amount to deduct based on a franchise fee.

12. A system for automatically determining a commission to be paid based on pluggable commission rule sets, the system comprising:
a receive-payment component configured to receive information corresponding to a payment from a transaction for division among one or more entities related to the transaction;
an enumerate-rules component configured to determine the commission rules that apply to a received payment;
an invoke-rules component configured to invoke the determined rules to deduct amounts from the received payment based on conditions specified by the rules; and
an output-result component configured to report the result of the deducted amounts from the received payment.

13. The system of claim 12 further comprising a prioritize-rules component configured to order rules by priority, wherein the invoke-rules component invokes rules according to the priority.

14. The system of claim 12 further comprising an edit-rules component configured to receiving modifications to one or more rules from a user, wherein the invoke-rules component invokes the latest version of the rules.

15. The system of claim 12 wherein the system is part of a web-based, hosted application accessed by a user over the Internet.

16. The system of claim 12 further comprising an export-data component configured to export the result of the deducted amounts to Intuit QuickBooks.

17. A computer-readable storage medium encoded with instructions for controlling a computer system to create rules for dividing a payment, by a method comprising:
providing an interface for receiving input that specifies one or more elements of a rule, wherein the rule determines an amount to be deducted from a received payment;
creating a rule based on the received elements; and
adding the rule to a set of rules accessible by an application configured to invoke one or more of the rules in the set when a payment is received,
such that the created rule modifies the behavior of the application without modifying the application itself.

18. The computer-readable medium of claim 17 wherein the interface comprises a form-based graphical user interface through which a user can enter the elements of the rule.

19. The computer-readable medium of claim 17 wherein the interface comprises a programmatic interface for automatically receiving the elements of the rule from another application.

20. The computer-readable medium of claim 17 wherein the one or more elements comprise at least a payment amount and an account to which the rule applies.

21. The computer-readable medium of claim 17 wherein creating the rule comprises generating a script that performs steps based on the specified elements of the rule.
